(19) United States
(12) Patent Application Publication
(10) Pub. No.: US 2008/0013262 A1
(43) Pub. Date: Jan. 17, 2008

(54) Computer monitor with detachable module

(75) Inventors: James Stanford, Danville, CA (US); Tony Poon, Albany, CA (US); Philippe Depallens, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/478,898

(22) Filed: Jun. 30, 2006

(51) Int. Cl. G06F 1/16

(52) U.S. Cl. 361/680

(57) ABSTRACT

A computer monitor including a frame member having an opening formed therein; a module that is configured to be placed in the opening and removed from the opening; a first electrical connector disposed on the frame member; and a second electrical connector disposed on the module, wherein the first and second electrical connectors are configured to transfer electrical signals therebetween.

### BACKGROUND OF THE INVENTION

The present invention generally relates to computer monitors. More specifically, the present invention relates to a computer monitor with a removable module.

Computer monitors for computer systems have changed from relatively large cathode-ray based systems to relatively slim flat panel based systems. Various attachments have been developed for both the cathode rays based systems and the flat-panel based systems. These attachments include web cams and the like that are configured to attached to these monitors.

U.S. Pat. No. 6,431,507, of Prather, assigned to Logitech, describes a web cam having a back arm and two front arms that are configured to be rotated relative to one another to attach the web ca0 to a top of a flat panel computer monitor.

U.S. Pat. No. 6,663,066, of Hong, assigned to KYE Systems, describes a web cam having a front arm and two back arms that are configured to translate relative to the front arm to couple the web cam to a flat panel computer monitor.

U.S. Pat. No. 6,481,681, of Stunkel, assigned to 3Com Corp., describes abase for a web cam, wherein the base includes a front arm and spring loaded flange that are configured to couple the base to a flat panel computer monitor.

U.S. Patent Publication No. 2005/0151042, of Watson, describes a base that includes trench that is configured to slide onto a top portion of a flat panel computer monitor to couple a web cam and a light to the flat panel computer monitor.

U.S. Patent Publication No. 2006/0088308, of Kenoyer, assigned to Lifesize Communications, describes a base for a web cam, wherein the base includes a front arm and a rotatable back arm that are configured to couple the web cam to a computer monitor, such as a flat panel computer monitor.

While various clips have been developed to couple web cams to computer monitors, new modular devices are needed that are configured to be removably couple to computer monitors.

### BRIEF SUMMARY OF THE INVENTION

The present invention generally provides a computer monitor. More specifically, the present invention provides a computer monitor with a removable module.

According to one embodiment of the present invention, the computer monitor includes a frame member having an opening formed therein; a module that is configured to be placed in the opening and removed from the opening; a first electrical connector disposed on the frame member; and a second electrical connector disposed on the module, wherein the first and second electrical connectors are configured to transfer electrical signals therebetween. The opening has a shape that is substantially complimentary to the shape of the module. The frame member is configured to frame a display panel of the computer monitor.

According to a specific embodiment, the module includes a web cam, a set of speakers, a set of lights, and/or a microphone. The module may also include a light sensor configured to detect the illumination on an area adjacent to the body, and the light sensor is configured to turn on the set of lights and/or adjust the brightness of the set of lights based on the detected illumination. The module is rotatable about a longitudinal axis of the module and/or about a vertical axis of the module. The module has the same form factor as the frame member.

According to another specific embodiment, the computer monitor further includes a first set of coupling members disposed on the frame member; a second set of coupling members disposed on the module. The first and the second coupling members are configured to removably couple the module to the frame member.

According to another embodiment of the present invention, a module is provided that includes a body that is configured to be removably coupled to an opening formed in a frame of a computer monitor. The body includes a web cam, a set of speakers, a set of lights, and/or a microphone. An electrical connector couple to the body is configured to electrically couple to an electrical connector of the computer monitor. The electrical connectors are configured to transfer electrical signals therebetween for a video signal and/or an audio signal. The electrical connectors are configured to operate according to a universal serial bus protocol. The computer monitor may be a flat panel display. The flat panel display may constitute a portion of a laptop computer. The body may also include a light sensor configured to detect the illumination on an area adjacent to the body, and the light sensor is configured to turn on the set of lights and/or adjust the brightness of the set of lights based on the detected illumination.

A better understanding of the nature and advantages of the present invention may be gained with reference to the following detailed description and the accompanying drawings.

### BRIEF DESCRIPTION OF THE DRAWINGS

FIG. 1 is a simplified schematic of a computer monitor according to an embodiment of the present invention;

FIG. 2 is a simplified schematic of computer monitor coupled to a removable module that includes a set of speakers and/or a microphone according to one embodiment of the present invention;

FIG. 3 illustrates the interchangeability of removable modules in a computer monitor;

FIG. 4 is a simplified schematic of a computer monitor having an opening formed therein, which is round;

FIG. 5 is a simplified schematic of a computer monitor having an opening formed therein, which is substantially triangular;

FIG. 6 is a simplified schematic of a computer monitor having a removable module, which includes a set of lights according to one embodiment of the present invention; and

FIG. 7 is a simplified schematic of a removable module according to another embodiment of the present invention.

### DETAILED DESCRIPTION OF THE INVENTION

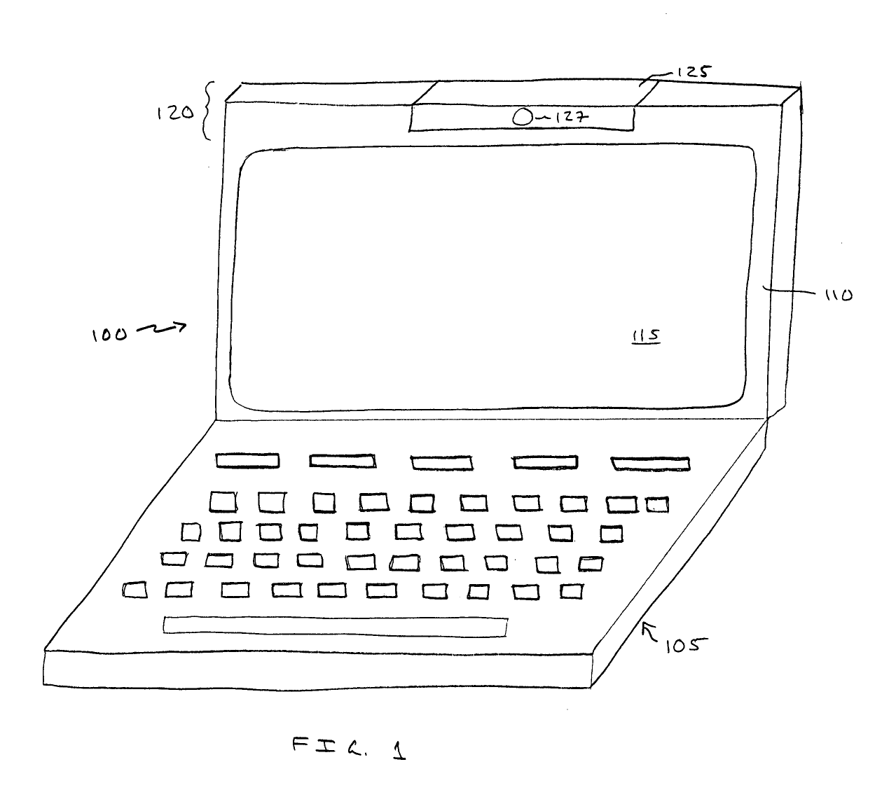

FIG. 1 is a simplified schematic of a computer monitor 100 according to an embodiment of the present invention. Computer monitor 100 may be a flat panel computer monitor, a cathode ray tube based computer monitor or the like. According to the embodiment of FIG. 1, computer monitor 100 is a flat panel computer monitor. The flat panel computer monitor may be a computer monitor for a laptop computer 105 or a desktop computer.

Computer monitor 100 includes a frame 110 that frames a display panel 115. Frame 110 includes a top frame member 120 that constitutes an upper portion of the computer monitor. According to one embodiment, a removable module 125 is coupled to the top frame member. Removable module 125 may be a device configured for use with the computer monitor and/or the computer associated with the computer monitor. The removable module may include a web cam, a microphone, a set of speakers, a music player (such as a music players the plays and/or stores MP3 files), a control device (such as a mouse, a remote control, etc.), a set of lights and/or the like. A set as referred to herein includes one or more members. According to the embodiment, of FIG. 1, the removable module includes a web cam 127.

According to one embodiment as shown in FIG. 1, the removable module may have substantially the same form factor as the frame. That is, with the removable module inserted in the top frame member, the removable module and top frame member have substantially a continuous shape, such as rectangular cube or the like. As referred to herein, a cube may sides that are square and/or rectangular.

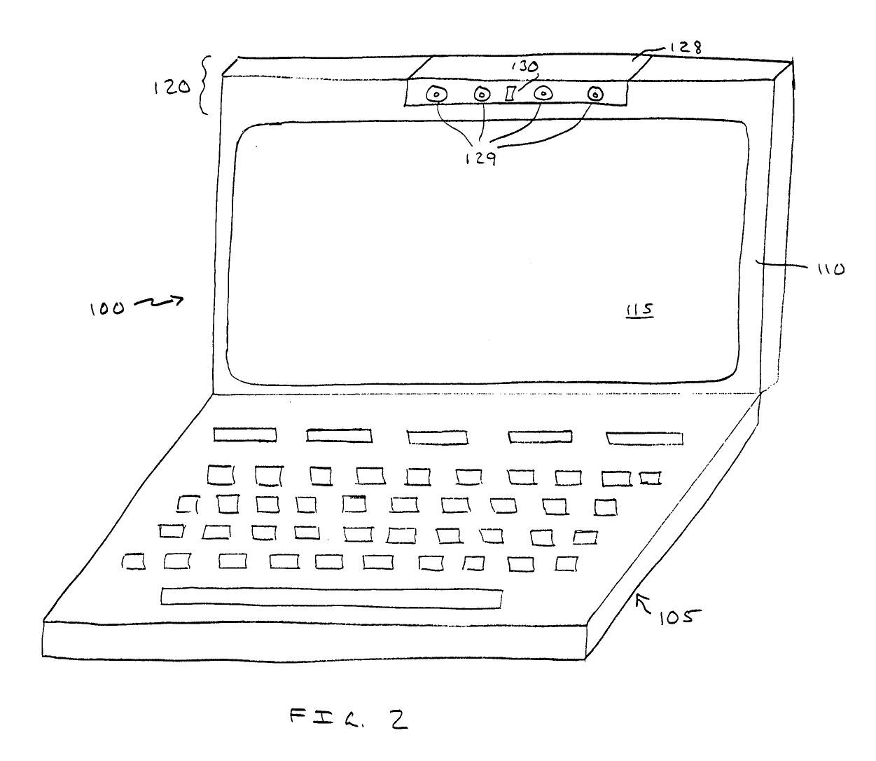

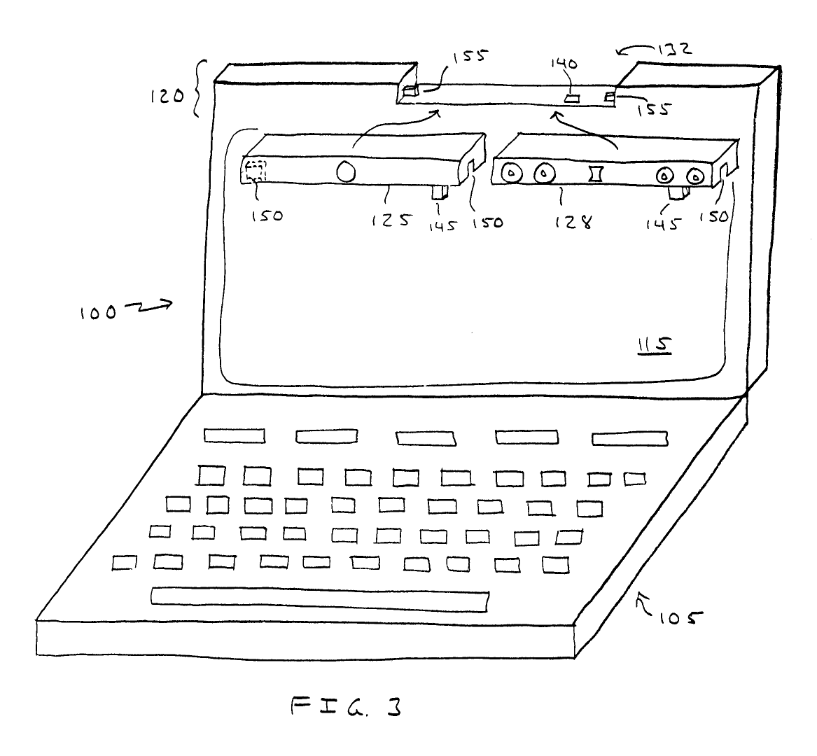

FIG. 2 is a simplified schematic of computer monitor 100 coupled to a removable module 128 that includes a set of speakers 129 and/or a microphone 130 according to one embodiment of the present invention. Removable module 128 may be configured to be exchanged with removable module 125 as illustrated in FIG. 3. More specifically, either removable module 125 or removable module 128 may be coupled to the computer monitor.

As shown in FIG. 3, each of the removable modules is configured to fit in an opening 132 that is formed in the top frame member. Opening 132 is shown in FIG. 3 as having a shape that is generally a rectangular cube; however, the opening may have a variety of shapes, such as square, triangular, round, capricious or the like. Removable modules according to various embodiments of the present invention may have a variety of shapes that are substantially complimentary to the variety of shapes of opening 132.

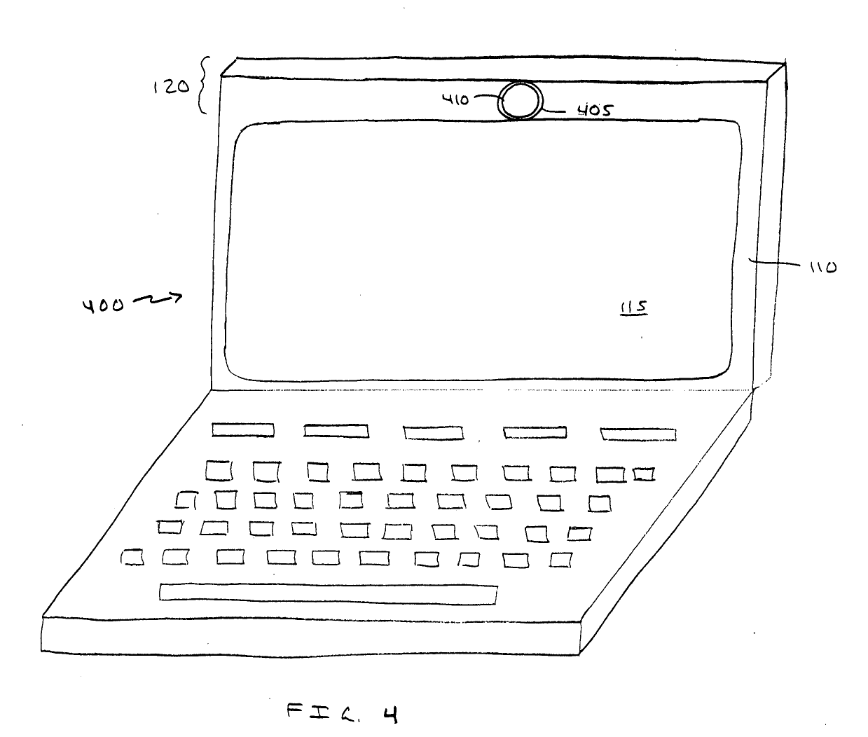

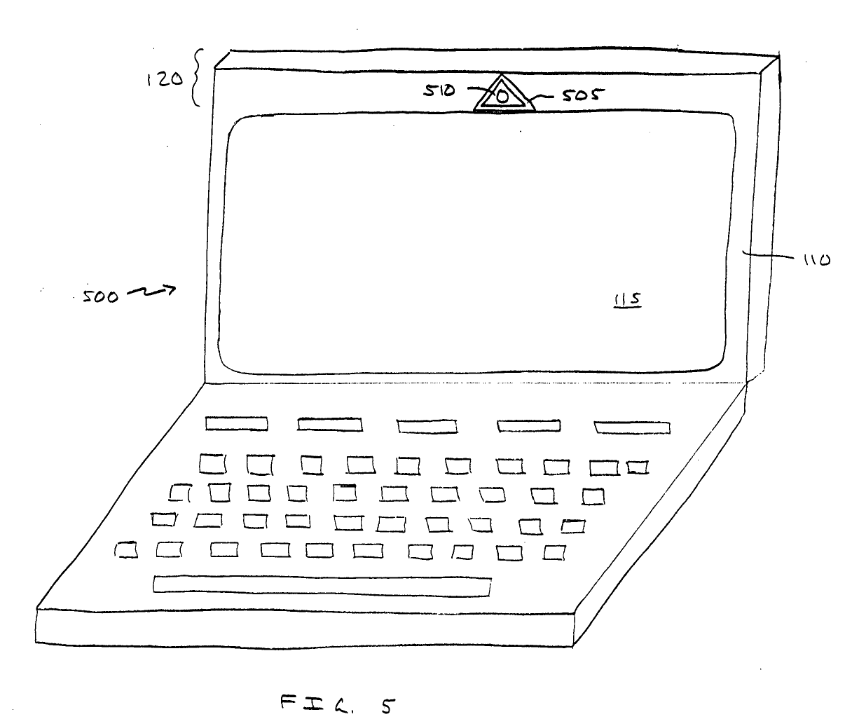

FIG. 4 is a simplified schematic of a computer monitor 400 having an opening 405 formed therein that is round. The round opening has a substantially round removable module 410 disposed therein. Opening 405 may be a slot into which the removable module may be inserted and removed from. Various ejections devices may be coupled to the frame and/or the removable module that are configured to eject the removable module from the opening. Ejection devices are well known in the art and are not described in detail herein. FIG. 5 is a simplified schematic of a computer monitor 500 having an opening 505 formed therein that is substantially triangular. The triangular opening has a removable module 510 disposed therein that is substantially triangular. It should be understood that the various shaped openings formed in the monitors and the various shaped removable modules are exemplary.

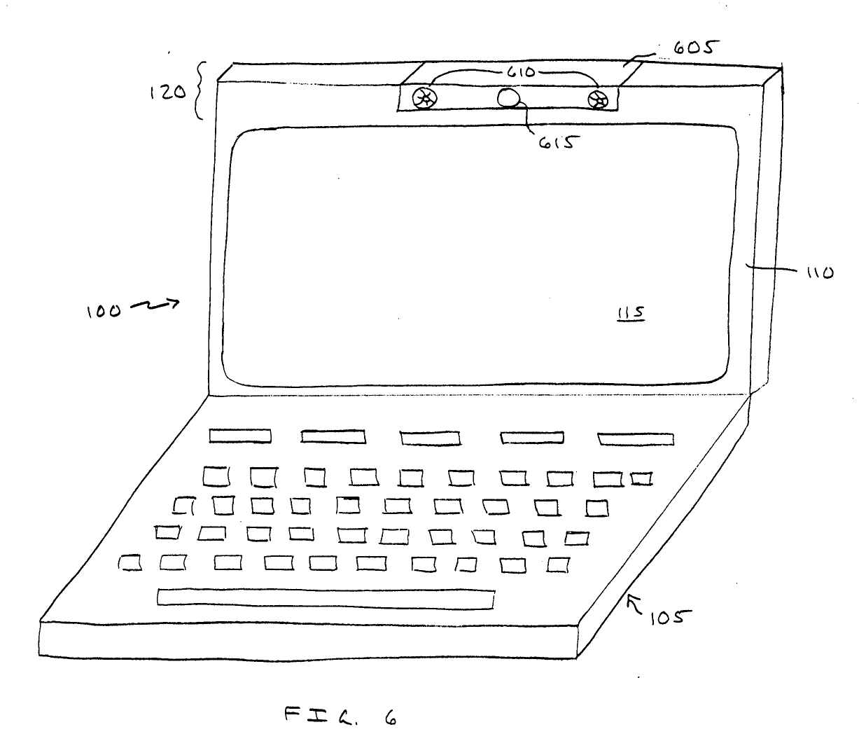

FIG. 6 is a simplified schematic of a computer monitor 600 having a removable module 605, which includes a set of lights 610 according to one embodiment of the present invention. The set of lights may be configured to illuminate the work surface (e.g., desk, keyboard, laptop keys, etc.) of a user or may be configured to illuminate the user. The set of lights might be configured to illuminate the user (e.g., the user's face) so that a web cam can collect illuminated images of the user. According to a specific embodiment, removable module 605 includes a light sensor 615 that is configured to detect the illumination of a work surface and/or a user. The removable module may be configured to turn on the set of lights and/or adjust the brightness of the set of light based on the amount of illumination detected by the light sensor. The removable module may be configured to adjust the light on the work surface or user to that images collected by the web cam are sufficiently lighted for substantially clear viewing by a viewer of the images. Substantially clear images may include images in which the details of a user's work on the user's desk top are sufficiently clear for reading or the like and/or the user's face is recognizable to those viewing the images.

According to another embodiment of the present invention, a removable module includes a set of lights, a web cam, a microphone, and/or a light sensor. The removable module might be configured to turn on the set of light and/or adjust the brightness of the set of lights based on the illumination of a work surface and/or the user detected by the light sensor or based on the brightness of the web cam images generated the web cam. According to another embodiment, the set of lights is substantially permanently fixed (i.e., light fixtures substantially permanently fixed with replaceable light sources, e.g., LEDs, light bulbs, etc.) to the monitor. That is, the set of lights might not be coupled to a removable module. The set of light might be disposed on various portion of the monitor's frame, such as one or more sides, the top, and/or the bottom portion of the frame.

Referring again to FIG. 3, computer monitor 100 includes a monitor connector 140 that is configured to couple to a module connector 145. Monitor connector 140 and module connector 145 are configured to transfer electrical signals to one another. For example, the monitor connector may be configured to receive video signals from the removable module if the removable module includes a web cam, a microphone or the like. Alternatively, the monitor connector may be configured to transfer electronic-audio signals to the removable module if the removable module includes a set of speakers. The electrical signals might also be sent bi-directionally between the monitor connector 140 and the module connector 145. For example, the removable module might includes a set of speakers and a microphone, and the modular connector might send electronic-audio signals to the removable module for the speakers and might receive electronic-audio signals from the microphone. According to one embodiment, the removable module and the computer monitor are configured to communicate via a universal serial bus (USB) protocol or the like.

According to one embodiment, the removable module includes a set of guide slots 150 that are configured to respectively couple to a set of guide tabs 155. The guide slot that is on the left of the removable module is shown in phantom. These slots and tabs may be configured to substantially hold the removable module in place on the computer monitor. According to one embodiment, a fastener, such as a screw, might also couple the removable module to the monitor. The removable module may be configured to be removed by the end user of the computer monitor or may be configured to be removed a technician. For example, if a removable module is broken, the removable module may be configured to be removed by a user who can send the removable module for service while the end user can continue to use the computer monitor absent the removable module.

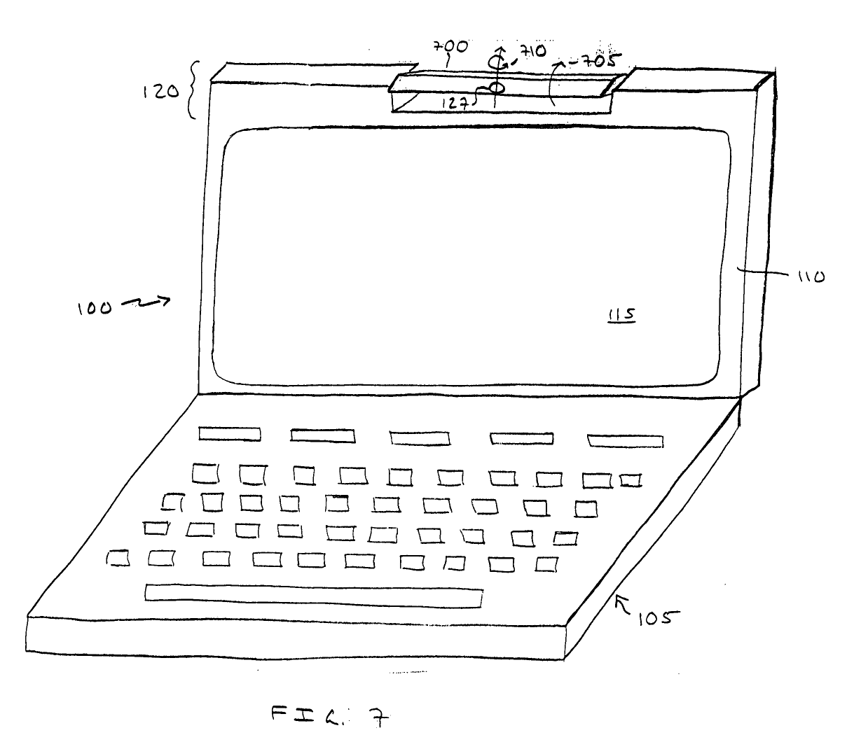

FIG. 7 is a simplified schematic of a removable module 700 according to another embodiment of the present invention. Removable module 700 differs from the removable modules described above in that removable module 700 is configure to be rotated up and down as indicated by arrow 705. Removable module 700 might also be configured to swivel left and right as indicated by arrow 710. The removable module might include various mechanisms that permit removable module 700 to be rotated up and down, and/or swiveled left and right. Those of skill in the art will know of various mechanism that might be used to permit removable module 700 to be rotated and/or swiveled and as such these mechanism are not be described in detail herein. While the removable module shown in FIG. 7 includes a web cam 127, removable module 700 might include a microphone, a set of speakers, and/or the like.

It is to be understood that the exemplary embodiments described above are for illustrative purposes and that various modifications or changes in light thereof will be suggested to persons skilled in the art and are to be included within the spirit and purview of this application and scope of the appended claims. For example, while the embodiments of the removable module are shown and described as being coupled to a top frame member, the removable module may be coupled to a side frame member of the frame. According to a further example, while the opening formed in the top frame members is shown and described as extending from the front of the top frame member to the back of the top frame member, the opening may not extend from the front to the back of the frame member, but might be a relatively shallow hole in the front surface of the frame. According to yet a further example, while the figures show one removable module coupled to the frame, two or more removable modules may be configured to be coupled to the frame of the computer monitor. The removable module may be configured to be placed into the shallow hole from the front of the computer monitor. Therefore, the above description should not be understood as limiting the scope of the invention as defined by the claims.

What is claimed is:

1. A computer monitor comprising:
a frame member having an opening formed therein;
a module that is configured to be placed in the opening and removed from the opening;
a first electrical connector disposed on the frame member; and
a second electrical connector disposed on the module, wherein the first and second electrical connectors are configured to transfer electrical signals therebetween.

2. The computer monitor of claim 1, wherein the module includes a web cam, a set of speakers, a set of lights, and/or a microphone.

3. The computer monitor of claim 2, wherein the module also includes a light sensor configured to detect the illumination on an area adjacent to the body, and the light sensor is configured to turn on the set of lights and/or adjust the brightness of the set of lights based on the detected illumination.

4. The computer monitor of claim 1, wherein the module is rotatable about a longitudinal axis of the module and/or about a vertical axis of the module.

5. The computer monitor of claim 1, wherein the module has the same form factor as the frame member.

6. The computer monitor of claim 1, further comprising:
a first set of coupling members disposed on the frame member; and
a second set of coupling members disposed on the module, wherein the first and the second coupling members are configured to removably couple the frame member and the module.

7. The computer monitor of claim 1, wherein the opening has a shape that is substantially complimentary to the shape of the module.

8. A computer monitor comprising:
a frame member having an opening formed therein, wherein the opening is configured to receive a module that is configured to be placed in the opening and removed from the opening;
an electrical connector disposed on the frame member and configured to transfer electrical signals to and/or receive electrical signal from the module; and
a coupling member disposed on the frame member and configured to couple the module to the frame member in the opening.

9. The computer monitor of claim 8, wherein the electrical connector is disposed on a surface of the frame members and the surface is in the opening.

10. The computer monitor of claim 8, wherein the electrical connector is a universal serial bus connector.

11. The computer monitor of claim 8, wherein the coupling member includes a set of guide tabs configured to coupled to complimentary shapes slots on the module.

12. The computer monitor of claim 8, wherein the opening is disposed on a top portion of the frame member.

13. The computer monitor of claim 8, wherein the opening has a shape that is substantially complimentary to a shape of the module.

14. The computer monitor of claim 13, wherein the opening has a shape that is substantially a rectangular cube and the module is substantially a rectangular cube.

15. The computer monitor of claim 8, wherein the module includes a web cam, a set of speakers, a set of lights, and/or a microphone.

16. A module comprising:
a body that is configured to be removably coupled to an opening formed in a frame of a computer monitor, wherein the body includes a web cam, a set of speakers, a set of lights, and/or a microphone; and
an electrical connector couple to the body and configured to electrically couple to an electrical connector of the computer monitor, where the electrical connectors are configured to transfer electrical signals therebetween for video and/or audio.

17. The module of claim 16, wherein the electrical connectors are configured to operate according to a universal serial bus protocol.

18. The module of claim 16, wherein the computer monitor is a flat panel computer monitor.

19. The module of claim 18, wherein the flat panel computer monitor constitutes a portion of a laptop computer.

20. The module of claim 16, wherein the body also includes a light sensor configured to detect the illumination on an area adjacent to the body, and the light sensor is configured to turn on the set of lights and/or adjust the brightness of the set of lights based on the detected illumination.
